(19) United States
(12) Patent Application Publication
(10) Pub. No.: US 2007/0091095 A1
(43) Pub. Date: Apr. 26, 2007

(54) Computer executable graphic method of generating animation elements

(76) Inventor: Ming-Jang Chen, Hsinchu City (TW)

Correspondence Address: RABIN & Berdo, PC, 1101 14TH STREET, NW, SUITE 500, WASHINGTON, DC, 20005, US

(21) Appl. No.: 11/583,703

(22) Filed: Oct. 20, 2006

(30) Foreign Application Priority Data
Oct. 21, 2005 (TW) 094136964

(51) Int. Cl. G06T 15/70

(52) U.S. Cl. 345/474

(57) ABSTRACT

A computer executable graphic method of generating animation elements realized with computer software is provided, which is capable of being plugged in a computer graphics application, recorded in a recording and storage medium, or executed on a computer executable platform. Through an operating mode of a graphic user interface provided by a graphics system, various objects can be established to form various animation elements, and the animation elements can be activated with a trigger event executed by an input device to generate various interactive animation effects. According to the present method, a user can operate in a graphic mode to establish and generate an interactive animation visually, simply, and rapidly.

### CROSS-REFERENCE TO RELATED APPLICATIONS

This non-provisional application claims priority under 35 U.S.C. § 119(a) on Patent Application No(s). 094136964 filed in Taiwan, R.O.C. on Oct. 21, 2005, the entire contents of which are hereby incorporated by reference.

### BACKGROUND OF THE INVENTION

1. Field of Invention

The present invention relates to a method of generating animation elements, and more particularly, to a graphic method of generating graphic animation elements which can be plugged in a computer graphics software application, recorded in a recording and storage medium, or executed in a computer software on a computer executable platform.

2. Related Art

Animation elements have long been indispensable elements on a multimedia interactive interface. In the past, two methods were mainly used to create animation elements: one is to create the elements with specialized computer graphics software application, such as FLASH, CorelDraw, and Photoshop; the other is to directly write programs in specialized computer program languages, such as Visual Basic and JAVA. However, the biggest problem in the two methods is that the platforms used are too specialized, and the users must be well trained for a long time to skillfully use the entire operating platforms to creating an animation element.

However, to most common users, the requirements on creating animation elements are often not so complicated. For example, for an application of teaching media, a user may only need to create sequential animation elements to display the created objects in a predetermined order, which is used to realize the interaction in teaching in conformity to the teaching material. If the elements are created with the computer graphics software application described above, the user has to select items meeting the requirements from among a large number of complicated functions. Otherwise, if the elements are created with the computer program language, the user has to write long program codes. The two methods cost much time, and cannot provide visual operational modes since the specialized platforms are used. Therefore, it is difficult for common users to easily use the two methods. Though the two methods have powerful animation element creating functions, they cannot satisfy the requirements of common users in actual applications.

Some well-known computer software programs, such as the presentation software program PowerPoint, can also provide the common users with the function of creating simple animation elements. However, the animation effects created with the functions of these software programs are limited, and the users have to create the elements step by step, so the entire process is quite long and complicated, and cannot meet the basic requirements of the common users on animation element creation.

Therefore, in order to satisfy the demand of the common users for animation element creation, a set of method of generating animation elements is required, which not only provides the users with a graphic operational mode, but also allows the users to create the animation elements visually, simply, and rapidly. Thus, the common users without too much specialized technical background can easily create animation elements.

### SUMMARY OF THE INVENTION

In view of the problems in the creation of animation elements with computer graphics application software programs and the computer program languages, the present invention is mainly directed to provide a computer executable graphic method of generating animation elements realized with a computer software program, such that a user can operate in a graphic mode, and establish and create interactive animation elements visually, simply, and rapidly.

To achieve the aforementioned objectives, an embodiment of the computer executable graphic method of generating animation elements disclosed in the present invention allows a user to create a switch animation element. To create the switch animation element, a functioning object and a switch object having a first form and a second form respectively must be defined first. The functioning object is established in the first form, wherein the functioning object includes at least a set of binary functioning attributes, and the set of binary functioning attributes is corresponding to a first functioning state and a second functioning state respectively. The switch object is established in the second form. The functioning object and the switch object form the switch animation element. When a trigger event from an input device is received, a switching of the binary functioning attributes is performed, such that the functioning object presents the first functioning state or the second functioning state to generate an animation effect like a switch.

Another embodiment of the computer executable graphic method of generating animation elements disclosed in the present invention allows the user to create a layered animation element. To create the layered animation element, functioning objects and switch objects having the first form and the second form respectively must be defined first. A plurality of functioning objects is sequentially established in the first form, wherein each of the functioning objects includes a set of binary functioning attributes, and each set of binary functioning attributes is corresponding to the first functioning state and the second functioning state respectively. A plurality of switch objects is sequentially established in the second form. The plurality of the functioning objects and the plurality of the switch objects are set to be a first layered object group and a second layered object group respectively. The first layered object group and the second layered object group form the layered animation element. When the trigger event received from the input device is activated in one of the switch objects in the second layered object layer, the switching of the corresponding binary functioning attributes of the functioning object of the same order of establishment in the first layered object group is executed, such that the functioning object presents the first functioning state or the second functioning state, and an animation effect with layered display is generated.

Another embodiment of the computer executable graphic method of generating animation elements disclosed in the present invention allows the user to create a sequential animation element. To create the sequential animation element, functioning objects and a switch object having the first form and the second form respectively must be defined first. A plurality of functioning object is sequentially established in the first form, wherein each of the functioning objects includes a set of binary functioning attributes, and each set of the binary functioning attributes is corresponding to the first functioning state and the second functioning state respectively. The switch object is established in the second form. When the trigger event received from the input device is activated several times continuously in the switch object, a switching of the binary functioning attributes is performed according to the sequence of establishment of the functioning objects, such that the functioning objects present the first functioning state or the second functioning state, so as to generate an animation effect of sequential display.

Another embodiment of the computer executable graphic method of generating animation elements disclosed in the present invention allows a user to create a switching animation element. To create the switching animation, functioning objects, switch objects, and a display object having the first form, the second form, and a fourth form respectively must be defined first. A plurality of functioning objects is sequentially established in the first form, wherein each of the functioning objects includes a set of binary functioning attributes, and each set of the binary functioning attributes is corresponding to the first functioning state and the second functioning state respectively. A plurality of switch objects is sequentially established in the second form. The display object is established in the fourth state. The functioning objects are scaled in the display object in the mode of maintaining the length-to-width ratio of the size of the display object. The switch objects, the functioning objects, and the display object form the switching animation element. When the trigger event is activated in one of the switching elements, the switching of the binary functioning attributes of the functioning object of the same order of establishment in the display object is executed, such that the functioning object presents the first functioning state or the second functioning state, and an animation effect that allows free display switching is generated.

The first form, the second form, the third form, and the fourth form refer to the preset attributes of the objects. The entire computer software program determines the definitions of the objects according to the attributes of the objects that the user establishes. In the computer executable graphic method of generating animation elements of the present invention, different lines are used to represent various attributes of the objects.

The animation elements can all be activated by the trigger event sent by the input device (a mouse in most cases), so as to enable the animation elements to present the corresponding animation effects.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an embodiment of various objects and forms according to the computer executable graphic method of generating animation elements of the present invention;

FIGS. 2a-2e are schematic views of generating a switch animation element according to the computer executable graphic method of generating animation elements of the present invention;

FIGS. 3a-3b are schematic views of generating a layered animation element according to the computer executable graphic method of generating animation elements of the present invention;

FIGS. 4a-4b are schematic views of generating a sequential animation element according to the computer executable graphic method of generating animation elements of the present invention;

FIGS. 5a, 5b, and 5c are schematic views of generating a switching animation element according to the computer executable graphic method of generating animation elements of the present invention; and

FIGS. 6a, 6b, and 6c are schematic views of an application embodiment of a full switch object according to the computer executable graphic method of generating animation elements of the present invention.

### DETAILED DESCRIPTION OF THE INVENTION

The present invention relates to a computer executable graphic method of generating animation elements realized through a computer software program. The computer software program can be recorded in a recording and storage medium, and plugged in a computer graphics application software program or started and executed on a computer executable platform as an independent graphics application software program. Through the computer graphics application software program or the computer software program, a graphic user interface operation mode can be provided for a user to create various animation elements. The animation elements are composed of objects created by the user, and can generate the animation effects required by the user according to different object attributes assigned by the computer software program and basic commands provided by the computer software program.

The generation of the animation effects is started by a trigger event executed with an input device which preferably is a mouse. The trigger event is generated by clicking at the position of the cursor controlled by the mouse. However, the so-called trigger event can also be generated by an input device such as a writing pad, a keyboard, or a touch screen. For example, when the cursor of the mouse moves onto an object, predetermined specific keys on the keyboard can be used to send keyboard signals to generate trigger signals.

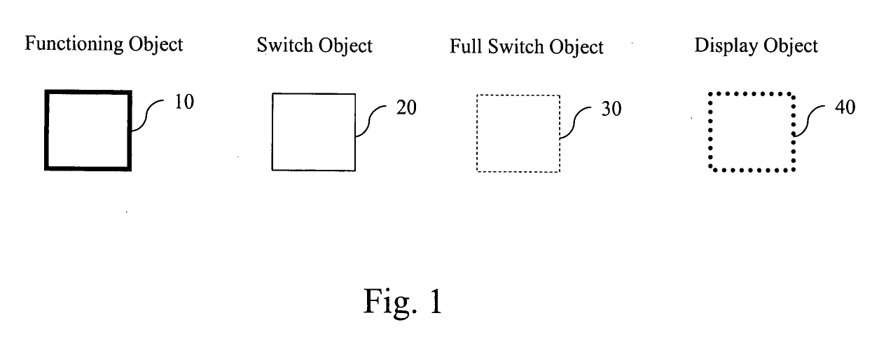

As far as the object attributes are concerned, in preferred embodiments of the present invention, different object attributes are represented by forms generated from different lines. Taking FIG. 1 as an example, four different forms of lines are used to represent the functioning object 10 (having the first form), the switch object 20 (having the second form), the full switch object 30 (having the third form), and the display object 40 (having the fourth form).

Each of the objects has a predetermined corresponding actuation procedure in the computer software program. In the description below, the functioning object 10 includes at least of a set of binary functioning attributes (enable attribute and disable attribute), and the set of binary functioning attributes are corresponding to the first functioning state (shown) and the second functioning state (not shown). The switch object 20 covers a scope capable of receiving the trigger event. When the trigger event is generated on the switch object 20, the switching of the binary functioning attributes of the functioning object 10 under control is triggered (i.e., switching from enable to disable or switching from disable to enable), such that the functioning object 10 under control presents different functioning states corresponding to the binary functioning attributes (i.e., converting form the first functioning state to the second functioning state or converting from the second functioning state to the first functioning state). The full switch object 30 covers the scope capable of receiving the trigger event. When the trigger event is generated in the scope of the full switch object 30, the switching of the binary functioning attributes of all functioning objects 10 is performed, such that all functioning objects 10 present the same functioning state simultaneously (i.e., presenting the first functioning state simultaneously or presenting the second functioning state simultaneously). The display object 40 is used to display the functioning state of the functioning object 10 controlled by the switch object 20. In particular, all functioning objects 10 placed in the display object 40 are placed in proportion to the size of the display object 40. When the trigger event is generated on the switch object 20, the switching of the binary functioning attributes of the functioning objects 10 under control will be triggered (i.e., switching form enable to disable or switching from disable to enable), such that the functioning objects 10 under control present different functioning states corresponding to the binary functioning attributes in the display object 40 (i.e., converting form the first functioning state to the second functioning state or converting from the second functioning state to the first functioning state).

The situation to plug the computer executable graphic method of generating animation elements of the present invention in the PowerPoint presentation software with a graphic user interface is described below, and basic animation elements, including the switch animation element, the layered animation element, the sequential animation element, and the switching animation element, created with the basic objects will be further illustrated. Many other animation elements can be derived from the concepts of creating these basic animation elements.

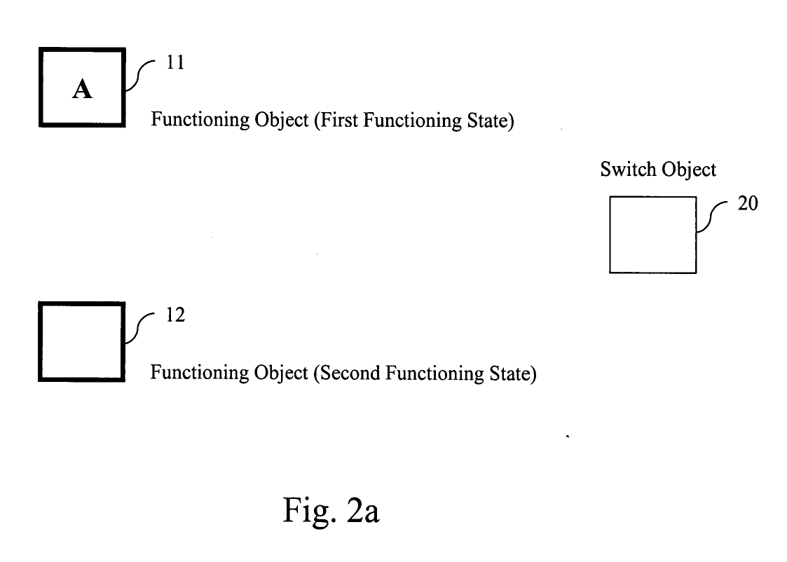

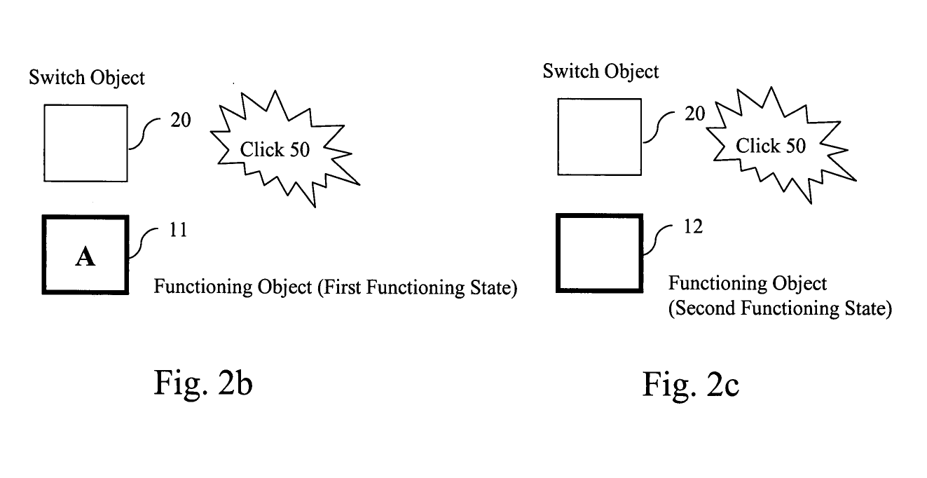

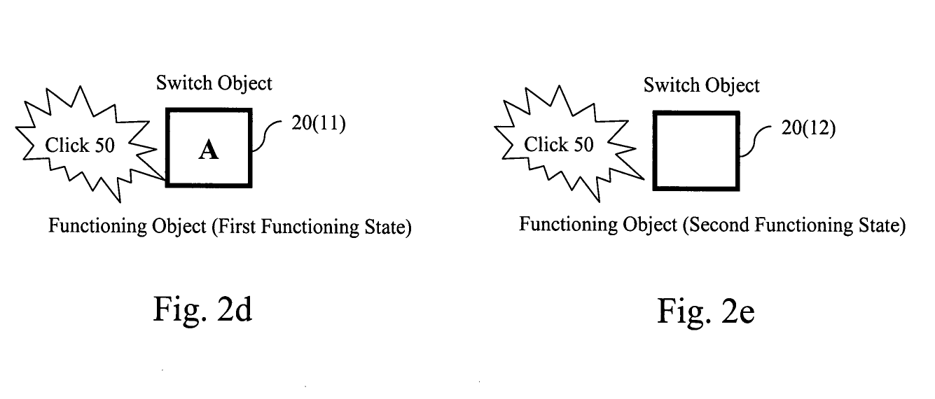

FIGS. 2a-2e are schematic views of creating a switch animation element according to an embodiment of the present invention. The entire switch animation element is composed of one functioning object 10 and one switch object 20. Therefore, the functioning object 10 having the first form and the switch object 20 having the second form must be created in a presentation document first. As described above, the functioning object 10 has the first functioning state and the second functioning state, which can be switched through the binary functioning attributes, for example, the functioning object (the first functioning state) 11 and the functioning object (the second functioning state) 12 in FIG. 2a.

When the presentation document is played and executed, the functioning object 10 initially is assumed to be in the functioning object (the second functioning state) 12. If a click 50 is performed on the switch object 20, the functioning object 10 changes into the aspect of the functioning object (the first functioning state) 11 as shown in FIG. 2b. If the click 50 is performed on the switch object 20 again, the functioning object 10 changes into the aspect of the functioning object (the second functioning state) 12 as shown in FIG. 2c again from the functioning object (the first functioning state) 11. By performing the click 50 on the switch object 20 repeatedly, the functioning object 10 presents the conversion between two different functioning states, thus realizing the animation effect like a switch.

If the color attribute of the switch element 20 is further set to be transparent, and the switch object 20 overlays on the functioning object 10, at this time, by performing the click 50 on the switch object 20 repeatedly, the switch animation element will present the switch animation effect as shown in FIG. 2d or 2e repeatedly, and this switch animation effect is more real.

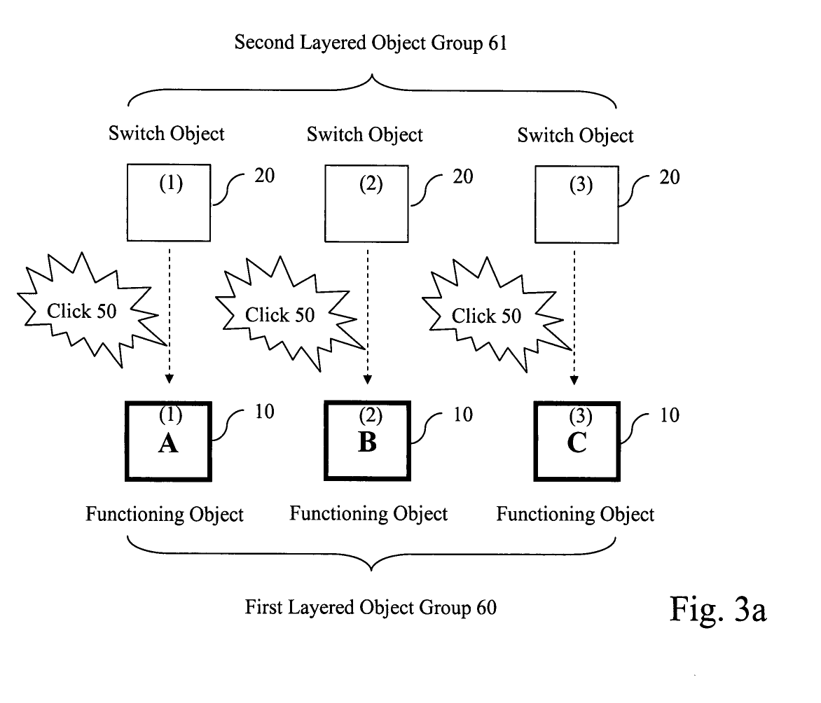

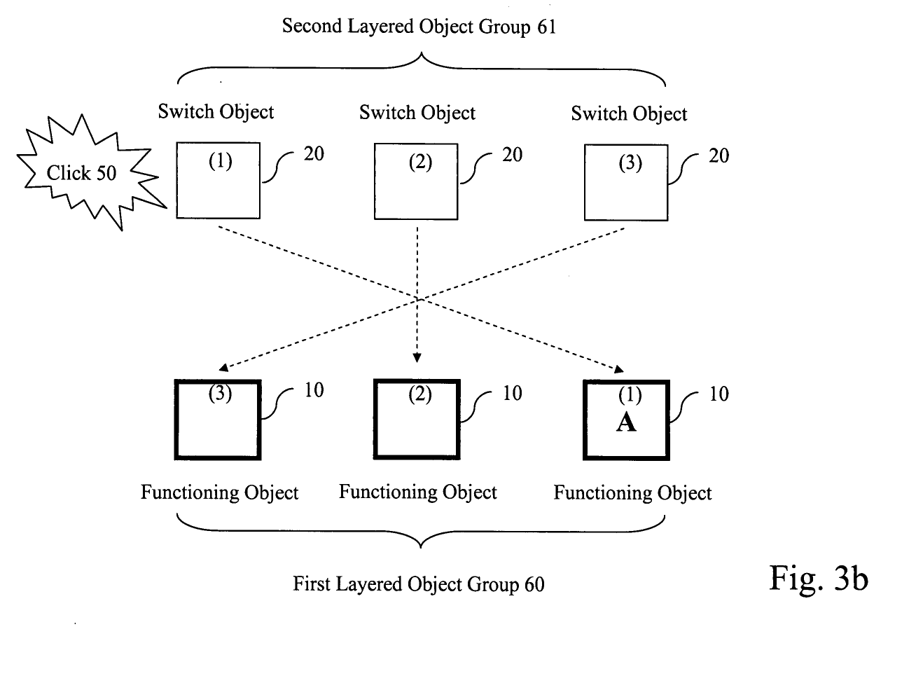

Then, FIGS. 3a and 3b are two embodiments of the layered animation element respectively. The layered animation element is composed of a first layered object group 60 including a plurality of functioning objects 10 and a second layered object group 61 including a plurality of switch objects 20 through a group set command. After the group setting, each of the functioning objects 10 in the first layered object group 60 is corresponding to the switch object 20 with the same object order in the second layered object group 61. (In FIGS. 3a and 3b, the numbers of the switch objects 20 and the functioning objects 10 represent the object orders then.)

When the presentation document is played, the corresponding functioning object 10 can change between different functioning states by performing the click 50 on the switch object 20. The operation of the switch object 20 and the corresponding functioning object 10 is similar to that of the switch animation element described above, and the details will not be described herein again. Similarly, by performing the click 50 on the switch object 20 repeatedly, the corresponding functioning object 10 will present repeated conversion between two different functioning states.

As for the order of the objects, generally the order of establishment of the objects is used to represent the order of the objects, which is a general conventional art. The order of the objects is decided according to the order that a user creates the objects. As shown in FIG. 3a, the dashed arrow between the switch object 20 and the functioning object 10 indicates the correspondence between the objects. When the switch object 20 is clicked, the corresponding functioning object 10 presents the conversion of the functioning states. The order of the objects can also be customized, for example, the order of the objects can be represented by the order that the user selects the objects. Therefore, the order of the objects can be freely modified through customizing, such that the correspondence between the switch object 20 and the functioning object 10 has more changes, as shown in FIG. 3b.

Therefore, the entire layered animation element can present animation effects in a layered way. Though only two layers (the first layered object group 60 and the second layered object group 61) are created, according to the concept of the switch animation element described above, more layers can be created during the creation of the layered animation element in practice. The operation thereof is the same as that of the aforementioned layered animation element, and the details will not be described herein again.

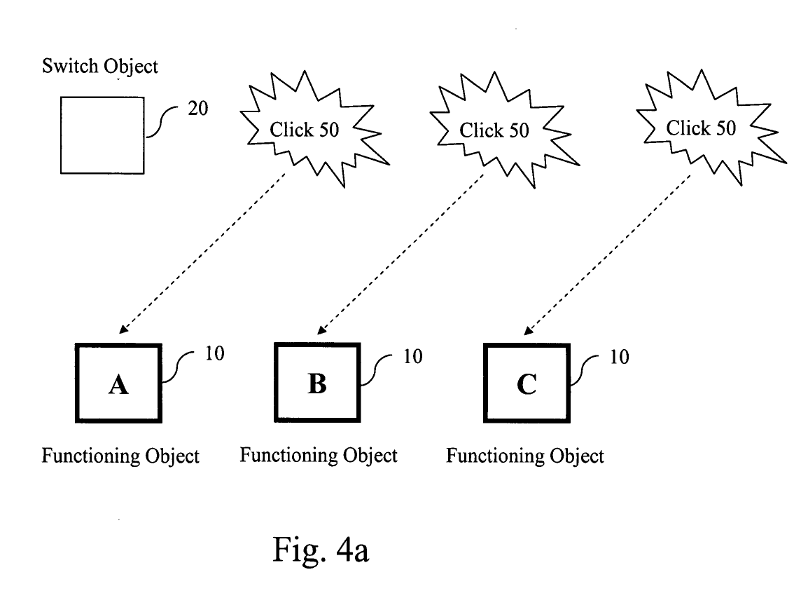

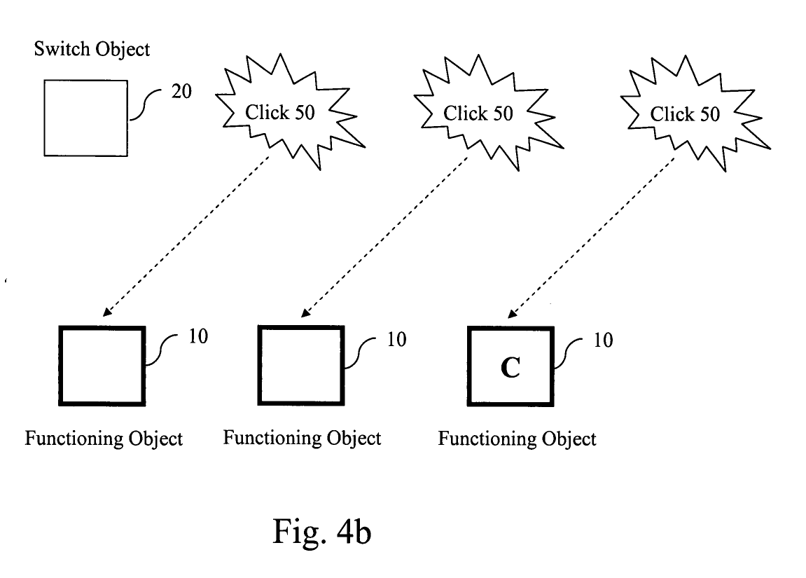

Another type of animation element is named as the sequential animation element. The entire sequential animation element formally uses one switch object 20 to control the functioning states of a plurality of functioning objects 10. After the above objects are set to be the sequential animation element through computer software program commands, when the trigger event is continuously started in the switch object 20 several times, all the functioning objects 10 present the switching of the functioning states sequentially according to the order of the objects. FIGS. 4a and 4b show implementation aspects of two different sequential animation elements respectively. The difference therebetween is that in FIG. 4a, when the click 50 is continuously performed on the switch object 20, the switching of the functioning states corresponding to the current functioning object 10 will not interfere the change of the functioning states of other preceding functioning objects 10. Therefore, after the click 50 is continuously performed on the switch object 20 three times as shown in the figure, all the functioning objects 10 present the same functioning state (the first functioning state). On the contrary, in FIG. 4b, when the click 50 is continuously performed on the switch object 20, the switching of the functioning states corresponding to the current functioning object 10 forces the change of the functioning states of other preceding functioning objects 10. Therefore, after the click 50 is continuously performed on the switch object 20 three times as shown in the figure, all the other functioning objects 10 presents the functioning state (the second functioning state) opposite to that of the current functioning object 10. This type of sequential animation element can generate the sequential animation effect, which makes the animation smooth.

The last basic animation element is the switching animation element, which at least includes the functioning objects 10, the switch objects 20, and the display object 40. Firstly, a plurality of functioning objects 10 and switch objects 20 are created sequentially, and then one display object 40 is created. With the commands provided by the computer software program, all the functioning objects 10 are scaled in the display object 40 in proportion to the size of the display object 40. When the trigger event is started on any one of the switch objects 20, the functioning object 10 of the same object order in the display object 40 will switch of the binary functioning attributes. When the click 50 is performed on other switch objects 20, the corresponding functioning objects 10 will produce the conversion of the functioning states.

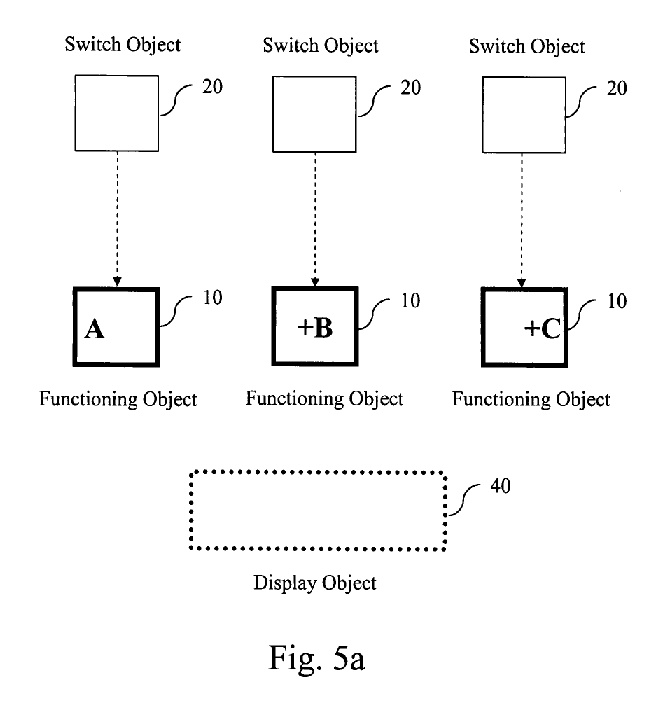

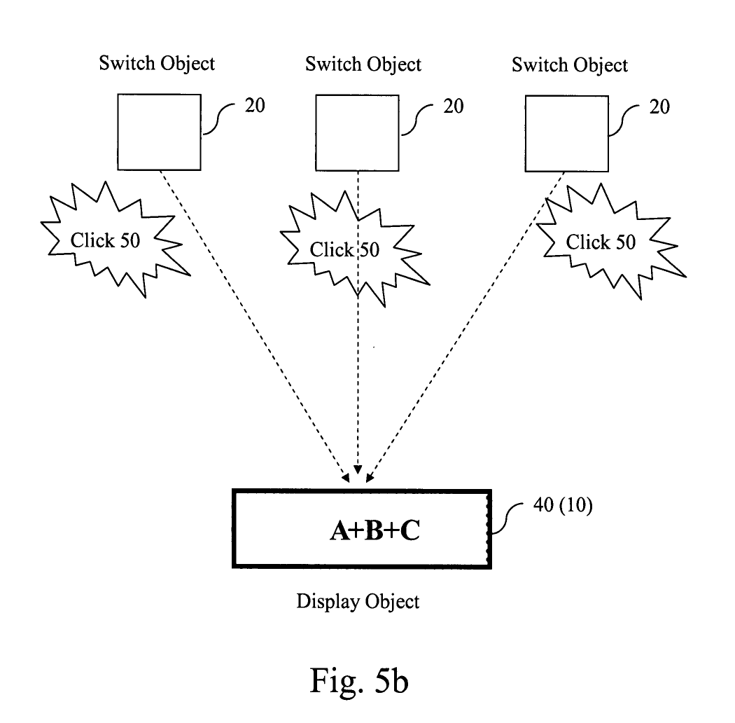

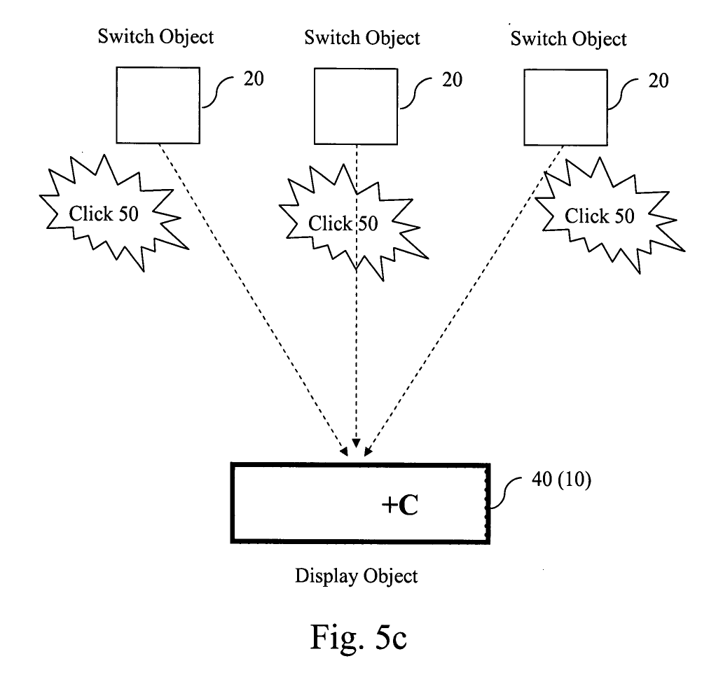

FIG. 5a shows the basic components of the switching animation element. In addition to the functioning objects 10 and the switch objects 20 (the dashed arrows in the figure represent the functioning objects 10 corresponding to different switch objects 20), the switching animation element further includes one display object 40. FIG. 5b shows that when all the functioning objects 10 are scaled in the display object 40 and at this time, the click 50 is performed on various switch objects 20 sequentially, all the functioning objects 10 present the first functioning state. The difference between FIG. 5c and FIG. 5b is that when the click 50 is performed on any one of the switch objects 20 to generate the trigger event, the functioning object 10 with the corresponding order will be switched to the first functioning state, and all the other functioning objects 10 that are not started will be switched to the second functioning state. Taking FIG. 5c as an example, when the click 50 is sequentially performed on all of the switch objects 20 to the rightmost switch object 20, the functioning object 10 corresponding to the rightmost switch object 20 will present the first functioning state (i.e., being displayed), while the other functioning objects 10 will be switched to the second functioning state (i.e., not being displayed).

In addition to the switch animation element, the layered animation element, the sequential animation element, and the switching animation element described above, sometimes to allow various functioning objects 10 in an animation element to restore the original state (usually the not displayed state) rapidly, the entire animation element looks like being reset and restarted. At this time, a customized full switch object 30 is required to execute this procedure. The main operation mode of the full switch object 30 is similar to that of the aforementioned switch object 20, while the difference is that the switch object 20 controls a single corresponding functioning object 10 and the full switch object 30 controls all of the functioning objects 10 of the current animation element.

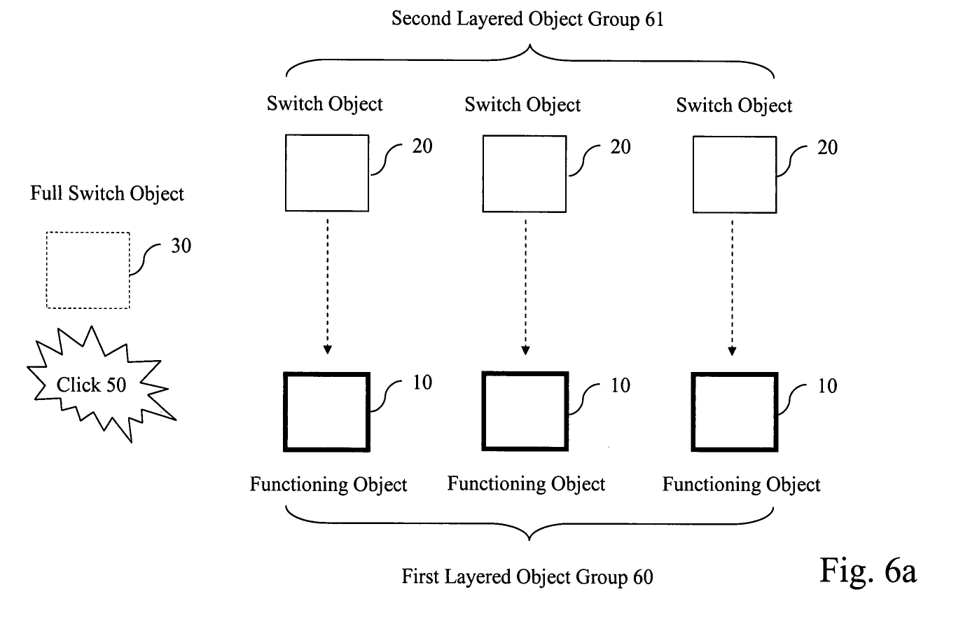

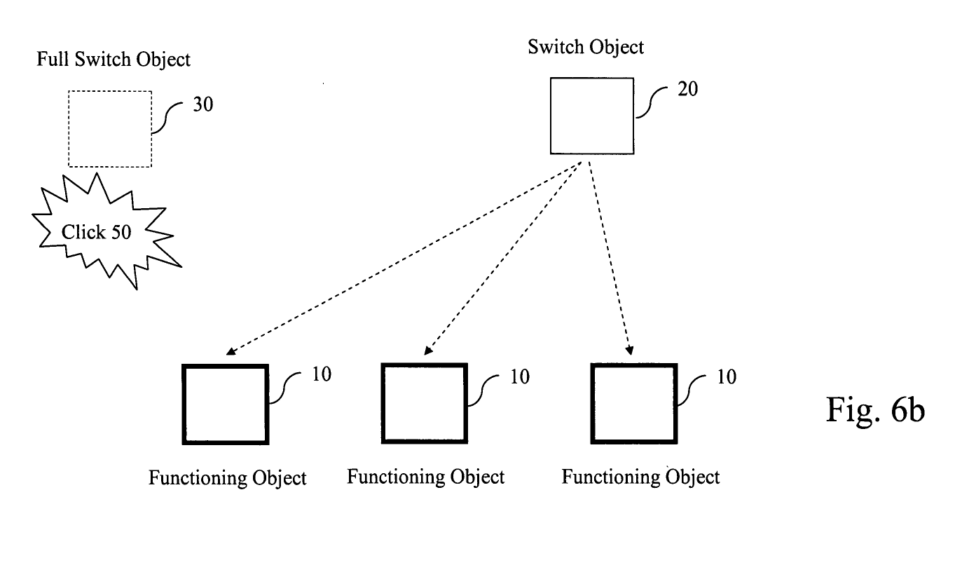

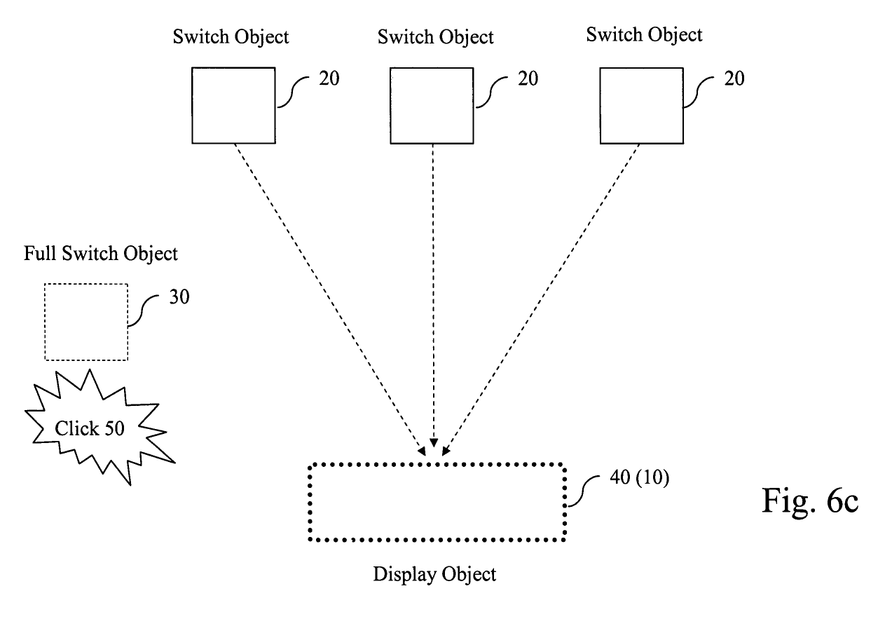

FIGS. 6a, 6b, and 6c show the situations that the full switch object 30 is applied in FIGS. 3a, 4a, and 5b respectively. When the click 50 is performed on the full switch object 30 to generate the trigger event, all the functioning objects 10 in the entire animation element are switched to have the same first functioning state or second functioning state, and usually switched to the second functioning state.

Currently, the aforementioned objects are mainly presented by geometrical patterns, such as circles, squares, rectangles, polygons, and triangles. The aforementioned objects and animation elements allow the operation processes such as central rotation, copy, paste, and scaling through the commands provided by computer software programs. The objects and animation elements after being processed maintain the original attributes, so as to facilitate the processing of large quantity of objects and animation elements.

Using the method of the present invention, many animation presentations having animation effects and interaction effects can be easily created and derived. Therefore, the method of the present invention has certain industrial use value in terms of the preparation of teaching materials and the creation of multimedia content. In addition, the graphic operation mode satisfies the basic requirements of common users for the creation of animation effects, and allows common users to create and generate desired animation effects most visually, easily, and rapidly in a short time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer executable method of generating animation elements applied to a computer executable platform with an input device, suitable for generating an animation element through operation of a graphic user interface, and allowing the animation element to generate a corresponding animation effect with a trigger event of the input device, the method comprising:
defining a functioning object having a first form and a switch object having a second form respectively;
establishing the first functioning object in the graphic user interface, wherein the first functioning object includes at least one set of binary functioning attributes, and the set of binary functioning attributes has a first functioning state and a second functioning state; and
establishing the first switch object in the graphic user interface, wherein the first switch object receives the trigger event generated by the input device to execute a switching of the set of binary functioning attributes of the first functioning object, such that the first functioning object presents the first functioning state or the second functioning state.

2. The computer executable method of generating animation elements as claimed in claim 1, wherein the method further comprises sequentially establishing a second functioning object and a third functioning object in the graphic user interface, when the first switch object receives a plurality of trigger events, sequentially executing the switching of the set of binary functioning attributes of the first functioning object according to an order of establishment of the first functioning object, the second functioning object, and the third functioning object, such that the first functioning object, the second functioning object, and the third functioning object sequentially present the first functioning state or sequentially present the second functioning state.

3. The computer executable method of generating animation elements as claimed in claim 2, wherein the method further comprises sequentially establishing a second switch object and a third switch object in the graphic user interface, when one of the first switch object, the second switch object, or the third switch object receives the trigger event, sequentially executing the switching of the set of binary functioning attributes of one of the first functioning object, the second functioning object, and the third functioning object having a same order of establishment as that of the first switch object, the second switch object, or the third switch object, so as to present the first functioning state or present the second functioning state.

4. The computer executable method of generating animation elements as claimed in claim 3, wherein the method further comprises establishing a display object having a fourth form in the graphic user interface, such that said all functioning objects are selectively scaled in the display object in equal length-to-width ratio of the size of the display object, when one of the first switch object, the second switch object, or the third switch object receives the trigger event, sequentially executing the switching of the set of binary functioning attributes of one of the first functioning object, the second functioning object, and the third functioning object having the same order of establishment as that of the first switch object, the second switch object, or the third switch object, so as to present the first functioning state or present the second functioning state in the display object.

5. The computer executable method of generating animation elements as claimed in claim 4, wherein the method further comprises when the current functioning object switches the set of binary functioning attributes, switching the set of binary functioning attributes of the functioning object of a previous order of establishment simultaneously, such that the functioning object of the previous order of establishment is switched to present the binary functioning attribute opposite to that of the current functioning object.

6. The computer executable method of generating animation elements as claimed in claim 4, wherein the method further comprises when the current functioning object switches the set of binary functioning attributes, switching the set of binary functioning attributes of the other functioning objects simultaneously, such that the other functioning objects are switched to present the binary functioning attribute opposite to that of the current functioning object.

7. The computer executable method of generating animation elements as claimed in claim 4, wherein the method further comprises establishing a full switch object having a third form in the graphic user interface, when the full switch object receives the trigger event, switching the set of binary functioning attributes corresponding to said all functioning objects to a same state, such that said all functioning objects present the first functioning state or present the second functioning state simultaneously.

8. The computer executable method of generating animation elements as claimed in claim 5, wherein the first form, the second form, the third form, and the fourth form refer to different forms of lines presented in the graphic user interface.

9. The computer executable method of generating animation elements as claimed in claim 5, wherein the trigger event is generated by using a mouse as the input device to control a cursor to click in areas of said all switch objects.

10. The computer executable method of generating animation elements as claimed in claim 5, wherein the trigger event is generated by using a writing pad as the input device to control a cursor to click in the areas of said all switch objects.

11. The computer executable method of generating animation elements as claimed in claim 5, wherein the trigger event is generated from a touch control signal produced by using a touch screen as the input device to perform selection in the areas of said all switch objects.

12. The computer executable method of generating animation elements as claimed in claim 5, wherein the trigger event is generated from a keyboard signal produced by using a keyboard as the input device and pressing the keyboard.

13. The computer executable method of generating animation elements as claimed in claim 5, wherein the binary functioning attributes are corresponding to an enable attribute and a disable attribute respectively.

14. The computer executable method of generating animation elements as claimed in claim 13, wherein the enable attribute is used to make the corresponding switch object to present the first functioning state of being displayed, and the disable attribute is used to make the corresponding switch object to present the second functioning state of not being displayed.

15. The computer executable method of generating animation elements as claimed in claim 5, wherein the functioning object, the switch object, the display object, and the full switch object are in the form of geometrical patterns.

16. The computer executable method of generating animation elements as claimed in claim 5, wherein the functioning objects, the switch objects, the display object, and the switch object, and the animation elements composed thereof are capable of executing operation of a central rotation process, a copy, a paste process, a zoom out process, and a zoom in process.

17. The computer executable method of generating animation elements as claimed in claim 5, wherein said all functioning objects or said all switch objects define the order of establishment according to an order of selection by the input device.

18. The computer executable method of generating animation elements as claimed in claim 5, wherein the switch object can fully overlap on the functioning object in a visually transparent manner.

19. A computer graphic interface application program capable of executing the computer executable method of generating animation elements as claimed in claim 1.

20. A recording and storage medium suitable for recording the computer graphic interface application program of the computer executable method of generating animation elements as claimed in claim 1.
